(19) United States
(12) Patent Application Publication
(10) Pub. No.: US 2015/0174742 A1
(43) Pub. Date: Jun. 25, 2015

(54) STRAP WRENCH

(71) Applicant: THE GATES CORPORATION, Denver, CO (US)

(72) Inventor: Ryan Osborn, Denver, CO (US)

(73) Assignee: THE GATES CORPORATION, Denver, C (unknown)

(21) Appl. No.: 14/137,389

(22) Filed: Dec. 20, 2013

(51) Int. Cl. B25B 13/52

(52) U.S. Cl. CPC B25B 13/52

(57) ABSTRACT

A strap wrench comprising a gripping member, a flexible member, an end of the gripping member comprising a first slot for receiving the flexible member, a locking member engagable within a flexible member wrap portion, the flexible member wrap portion and locking member having an interference engagement within the first slot, a second slot parallel to the first slot for receiving another end of the flexible member, and the locking member having a tapered cross-sectional form and having a surface texture for frictionally engaging the flexible member wrap portion within the first slot.

### FIELD OF THE INVENTION

The invention relates to a strap wrench, and further to a strap wrench comprising a locking member having a cross-sectional form and having a surface texture for frictionally engaging a flexible member wrap portion within a first slot.

### BACKGROUND OF THE INVENTION

Many different strap wrenches have been developed over the years. Most include a strap attached to a handle, with a loose end that is coupled to the handle once the loop of the strap is made to be a desired size. The handle provides leverage to tighten the strap while turning the object enclosed by the strap.

Some strap wrenches have a tendency for the strap to slip on the work as the handle is turned. In others the loose end of the strap will loosen while the handle is turned.

Various uses include as oil filter wrenches or for removal of chain sprockets. Strap wrenches may be used on any workpiece that is not amenable to a box end or open end wrench, such as large diameter workpieces.

Representative of the art is U.S. Pat. No. 8,555,753 which discloses a strap wrench including a strap that is a continuous loop and has notches. No portion of the strap is affixed to any portion of the wrench. The strap is placed around an object that needs to be turned such as an oil filter on an engine. A tension mechanism is then used to tighten the strap into place around the object to be turned. A ratchet mechanism engages one or more notches on the strap to prevent movement of the strap in one direction while allowing movement of the strap in the opposite direction. The combination of the notched continuous loop strap and ratchet mechanism allow the strap wrench to have a ratcheting action after the strap is tightened into place around the object to be turned.

What is needed is a strap wrench comprising a locking member having a cross-sectional form and having a surface texture for frictionally engaging a flexible member wrap portion within a first slot. The present invention meets this need.

### SUMMARY OF THE INVENTION

The primary aspect of the invention is to provide a strap wrench comprising a locking member having a cross-sectional form and having a surface texture for frictionally engaging a flexible member wrap portion within a first slot.

Other aspects of the invention will be pointed out or made obvious by the following description of the invention and the accompanying drawings.

The invention comprises a strap wrench comprising a gripping member, a flexible member, an end of the gripping member comprising a first slot for receiving the flexible member, a locking member engagable within a flexible member wrap portion, the flexible member wrap portion and locking member having an interference engagement within the first slot, a second slot parallel to the first slot for receiving another end of the flexible member, and the locking member having a tapered cross-sectional form and having a surface texture for frictionally engaging the flexible member wrap portion within the first slot.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a bottom perspective view of the strap wrench.

FIG. 2 is a top perspective view of the strap wrench.

FIG. 3 is a cross-sectional view of the strap wrench.

FIG. 4 is a perspective view of the locking member.

FIG. 5 is a cross-sectional view of the locking member.

FIG. 6 is a top perspective view of the wrench head.

FIG. 7 is a bottom perspective view of the wrench head.

FIG. 8 is a perspective view of an alternate locking member.

FIG. 9 is an end view of the alternate locking member in FIG. 8.

### DETAILED DESCRIPTION OF THE PREFERRED EMBODIMENT

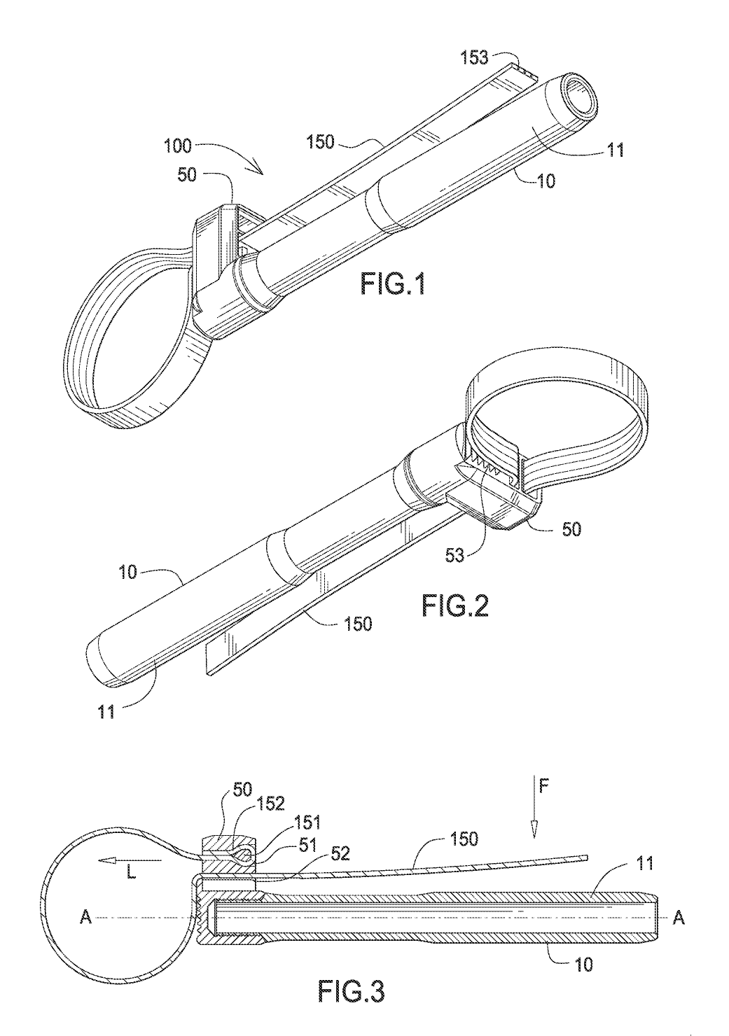

FIG. 1 is a bottom perspective view of the strap wrench. The inventive strap wrench comprises a gripping member 10 connected to an end or head portion 50. A flexible member 150 is engaged with end 50.

Flexible member 150 comprises a strap of any suitable material known in the art, for example, elastomer, nylon, poly, metallic or natural material. Flexible member 150 may also comprise a multi-ribbed belt used for power transmission in the automotive or industrial industries. The multi-ribbed belt may comprise a plurality of tensile cords 153 embedded in the belt which enhance the tensile load bearing properties of the belt. The tensile cords run in a lengthwise direction. In the multi-ribbed embodiment the ribs run lengthwise in the longitudinal direction. Flexible member 150 is not a continuous loop, that is, it comprises a length having a proximal and distal end. Flexible member 150 may also be flat on both sides wherein a multi-ribbed surface is not present.

FIG. 2 is a top perspective view of the strap wrench. Surface 11 is for a user to grip the tool.

FIG. 3 is a cross-sectional view of the strap wrench. End 50 comprises a first slot 51 and a second slot 52. First slot 51 and second slot 52 are parallel. Gripping member 10 comprises a gripping member centerline axis A-A. Second slot 52 is disposed between the first slot 51 and gripping member axis A-A with reference to a direction normal to axis A-A. First slot 51 is disposed radially outward of the second slot 52 with respect to the gripping member.

Flexible member wrap portion 152 is wrapped about a locking member 151. Wrap portion 152 and locking member 151 have an interference fit within first slot 51, thereby preventing pull out of the flexible member during use. First slot 51 is wider at one end 51b to facilitate the interference fit, see FIG. 7. Wider end 51b of first slot is the end that receives the wrap portion and locking member combination. The end of flexible member 150 which is wrapped about locking member 151 extends within the first slot and is then folded back on itself so it reengages flexible member 150, all within first slot 51.

When in use the flexible member 150 exerts a force “L” on wrap portion 152 and locking member 151. Force “L” is represented by a vector L. An end of the flexible member is disposed for pressing engagement against the gripping member 10 by a user. A user grips the gripping member while simultaneously gripping a loose end of the flexible member 150 thereby pressing it against the gripping member surface 11 which is knurled. Knurling on surface 11 enhances the grip capacity on the flexible member, which increases the torque capacity of the strap wrench. A force F applied by a user causes flexible member 150 to tightly engage a work piece (not shown).

The size capacity of the wrench may be adjusted by either extending or retracting the loose end of the flexible member through second slot 52. The loose end of flexible member 150 is simply pulled snug against the work piece and then gripped against surface 11 by the user.

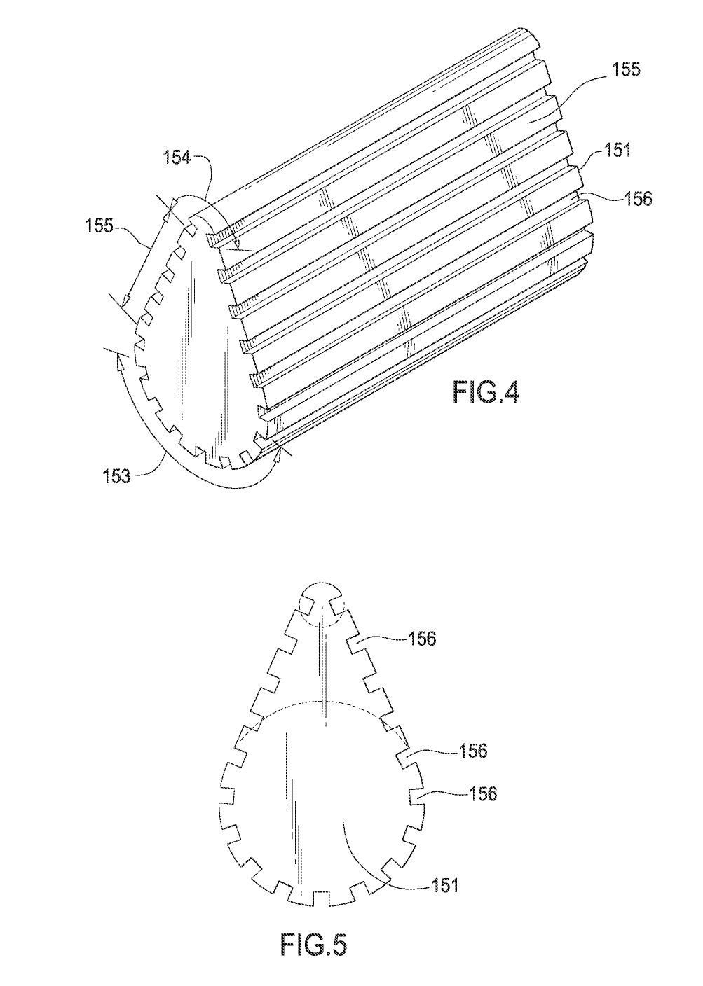

FIG. 4 is a perspective view of the locking member. Locking member 151 comprises a tapered form when viewed in cross-section. Locking member 151 comprises a textured surface which engages the flexible member 150. The textured surface may comprise a plurality of parallel elongate grooves 156 extending normal to the taper direction for gripping the flexible member 150 within the first slot 51. The textured surface of locking member 151 may also comprise knurling, striations or any other surface feature suitable for a frictional engagement with the flexible member 150.

FIG. 5 is a cross-sectional view of the locking member. When engaged in first slot 51 the taper of locking member 151 from broad end to narrow end extends in the direction of vector L, see FIG. 3. Locking member 151 comprises a major curved portion 153 which faces a minor curved portion 154. The radius of the major curved portion is greater than the radius of the minor curved portion. Planar portions 155 extend between portion 153 and portion 154. This may also be referred to as a “tear drop” shape.

Grooves 156 comprise a rectilinear cross-section, see FIG. 5. The rectilinear cross-section facilitates the frictional gripping action between locking member 151 and the flexible member 150. Grooves 156 may also be triangular, arcuate or other suitable cross-section to create a frictional engagement with the flexible member 150.

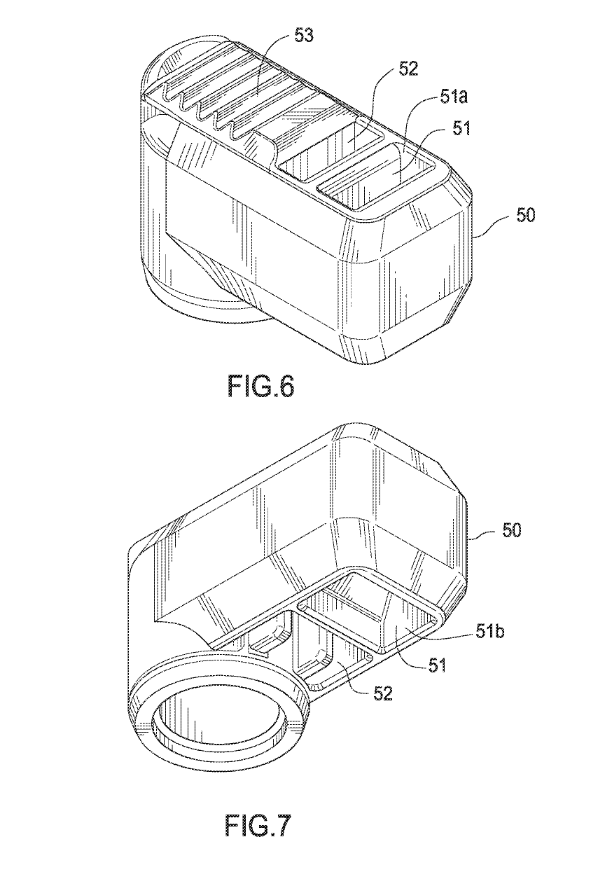

FIG. 6 is a top perspective view of the wrench head. Wrench head 50 is disposed at an end of gripping member 10. First slot 51 and second slot 52 are adjacent to each other and are parallel. Ribbed surface 53 is disposed adjacent second slot 52. Ribbed surface 53 engages flexible member 150 to increase purchase when the wrench is in use.

FIG. 7 is a bottom perspective view of the wrench head.

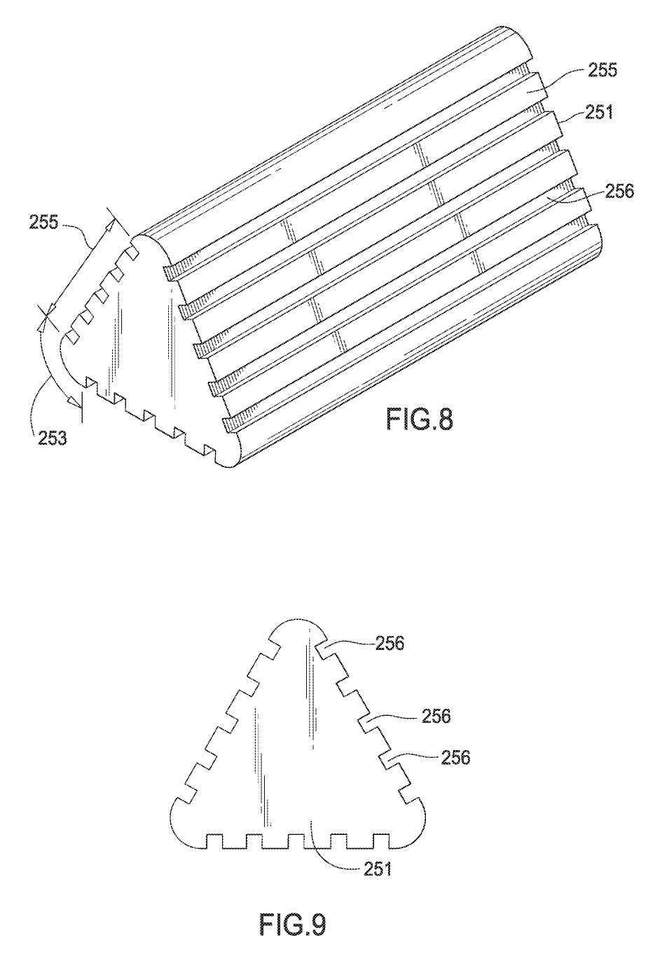

FIG. 8 is a perspective view of an alternate locking member. In an alternate embodiment locking member 251 may comprise a triangular cross-section having three sides 255. Sides 255 are joined by arcuate vertices 253 disposed therebetween. Locking member 251 is a triangular cross-section may comprise a smooth, textured, or grooved surface 256 for frictionally gripping the flexible member 150 within the first slot 51. Locking member 251 may also comprise a circular cross-section having a smooth, textured or grooved surface for gripping the flexible member 150 within the first slot 51.

Grooves 256 comprise a rectilinear cross-section. The rectilinear cross-section facilitates the gripping action between locking member 251 and the flexible member 150. Grooves 256 may also be triangular, arcuate or other suitable cross-section to create a frictional engagement with the flexible member 150. FIG. 9 is an end view of the alternate locking member in FIG. 8.

Although a form of the invention has been described herein, it will be obvious to those skilled in the art that variations may be made in the construction and relation of parts without departing from the spirit and scope of the invention described herein.

We claim:

1. A strap wrench comprising:
a gripping member (10);
a flexible member (150);
an end of the gripping member comprising a first slot (51) for receiving the flexible member;
a locking member (151) engagable within a flexible member wrap portion (152);
the flexible member wrap portion and locking member having an interference engagement within the first slot;
a second slot (52) parallel to the first slot for receiving another end of the flexible member; and
the locking member having a tapered cross-sectional form and having a surface texture (156) for frictionally engaging the flexible member wrap portion within the first slot.

2. The strap wrench as in claim 1 further comprising a textured surface disposed adjacent to the first slot for engaging the flexible member.

3. The strap wrench as in claim 1, wherein the flexible member comprises a multi-ribbed belt.

4. The strap wrench as in claim 1, wherein the end extends normally from the end of the gripping member.

5. The strap wrench as in claim 2, wherein the second slot is disposed between the first slot and the textured surface.

6. The strap wrench as in claim 1, wherein the locking member major axis is oriented parallel to a flexible member tensile load vector.

7. The strap wrench as in claim 1, wherein the surface texture comprises parallel elongate grooves extending normal to the taper direction.

8. A strap wrench comprising:
a gripping member having a first slot disposed radially outward from a gripping member axis;
a flexible member;
a locking member having a predetermined cross-sectional form and having a plurality of elongate grooves for gripping the flexible member within the first slot; and
a second slot for receiving another end of the flexible member, the second slot disposed between the first slot and the gripping portion axis.

9. A strap wrench comprising:
a gripping member having a first slot, and a second slot parallel to the first slot;
a flexible member having a flexible member wrap portion receivable by the first slot, the flexible member receivable by the second slot; and
a locking member having a surface texture feature for an interference fit when engaged with the flexible member wrap portion within the first slot.

10. The strap wrench as in claim 9, wherein the flexible member comprises a multi-ribbed belt.

11. The strap wrench as in claim 9, wherein the surface texture feature comprises a plurality of grooves.

12. The strap wrench as in claim 9, wherein the locking member comprises a tapered form.

13. The strap wrench as in claim 9, wherein the locking feature comprises a triangular form.

14. The strap wrench as in claim 9 further comprising a ribbed surface adjacent the second slot.

15. The strap wrench as in claim 9, wherein the gripping member further comprises a knurled surface.

16. The strap wrench as in claim 9, wherein the second slot is disposed between the first slot and the gripping member.

17. The strap wrench as in claim 9, wherein the first slot is disposed radially outward from the second slot with respect to a gripping member axis (A-A).

18. The strap wrench as in claim 9, wherein the first slot is wider at one end.

19. The strap wrench as in claim 9, wherein the flexible member comprises tensile cords.

20. The strap wrench as in claim 9, wherein an end of the flexible member is disposed for pressing engagement against the gripping member.
